(19) United States
(12) Patent Application Publication
(10) Pub. No.: US 2004/0089400 A1
(43) Pub. Date: May 13, 2004

(54) Method and apparatus for forming an annular elastomeric tire component

(76) Inventors: Richard David Vargo, Cuyahoga Falls, OH (US); Gary Robert Burg, Massillon, OH (US); Brian Richard Koch, Hartville, OH (US); Mark Anthony Sieverding, Uniontown, OH (US)

Correspondence Address: The Goodyear Tire & Rubber Company, Patent & Trademark Department - D/823, 1144 East Market Street, Akron, OH, 44316-0001, US

(21) Appl. No.: 10/291,279

(22) Filed: Nov. 8, 2002

(51) Int. Cl. B29D 30/06; B29D 30/00

(52) U.S. Cl. 156/136; 156/123; 156/110.1; 156/394.1

(57) ABSTRACT

A method and apparatus 100 for forming an annular elastomeric tire component has the steps of extruding at least one elastomeric material annularly onto a support surface 60 and shaping the at least one strip 2 of elastomeric material to a predetermined profile by forming the at least one strip 2 of material between a shaping die 84 and the support surface 60 thereby smoothing and spreading the strip to the desired profile. The method may include applying additional strips 2 to form multilayered components. The support surface 60 may be separate from a tire building station 200 or may be integral to a tire building station 200. The formed strips may include any one or more tire components such as a sidewall 20, a chafer 30, a bead apex 10, ply stock coatings 40, an innerliner 50, or a tread 22.

### TECHNICAL FIELD

This invention relates to a method and apparatus for forming profiled annular elastomeric tire components.

### BACKGROUND OF THE INVENTION

In the manufacture of tire components elastomeric strips of rubber are prepared typically by extruding the parts into long continuous strips which are cut to length and lapped or butt spliced onto a cylindrically shaped building drum.

The tire building drum is then expanded radially in the center and the ends are drawn in axially to shape the tire into a toroidial form. Belts of cord-reinforced layers and a strip of tread rubber are applied over the crown of the green carcass to form a “green” or unvulcanized tire assembly.

The finished tire assembly is then placed into a tire mold and cured in a process called vulcanization to make a tire.

Since the tire components are assembled flat on a cylindrical tire building drum and then expanded to a toroidial shape, each component has to be placed in tension or compression prior to being molded. This stretching of the various parts causes slippage between the various rubber parts as the components heat up during vulcanization.

Attempts to minimize the slippage of the various parts have been attempted.

One area of particular concern is the bead apex. The bead apex is a rubber component that lies directly above an annular tensile member commonly referred to as a bead core. The shape of the bead apex is generally an elongated triangular shape. The tire's carcass plies lie adjacent the radially inner surface of the bead apex and generally wrap around the bead core and extend along the axially outer surface of the bead apex in what is commonly referred to as the ply turnup.

When the tire is built flat the apex must be turned 90° to an upright position. This forces the radially outermost tip of the bead apex to stretch circumferentially a large amount resulting in high stresses and localized thinning of the bead apex.

In U.S. Pat. No. 6,298,893 to Vannan precured bead apexes are manufactured so that the ply path of the carcass plies can be more reliably controlled. As Vannan notes the tensioning of the ply cords and their location relative to the natural ply path of the tire are mostly controlled by the bead apex. Vannan's solution was to preassemble and precure the bead core and the bead apex. While this approach greatly improves the stability of the bead apex it has the major drawback of lacking the adhesion properties found when green or uncured components are assembled.

Attempts have been made to make uncured strips of bead apexes but the elongated tip of these apexes when formed into an annular ring tend to warp and buckle as the extrudate shrinks and reduces tension and cools. This warping or buckling renders such parts useless. Accordingly, only very short squatty apexes lend themselves to this type of preforming.

It is one object of the present invention to provide a method and apparatus that can form an annular elastomeric strip such as an apex component without the unwanted stretching or warping of the tip.

It is a further object of the invention to provide a method and apparatus for making an elongated apex or other strip of tire material in a profile oriented very close to the shape of the finished molded tire.

It is yet a further object to provide a method for manufacturing multilayered components of different materials or multilayered components of similar material.

It is yet another object to provide a method that creates a smooth overlap of the beginning of an annular component and an end of the component such that the part appears seamless.

### SUMMARY OF THE INVENTION

A method of forming an annular elastomeric tire component has the steps of extruding at least one strip of elastomeric material annularly onto a support surface or a previously formed strip or component, shaping the at least one strip of elastomeric material to a predetermined profile by forming or smearing the at least one strip of material between a shaping die and the support surface thereby smoothing and shaping the at least one strip to the desired profile.

The predetermined profile may have non-parallel opposing surfaces or non-linear parallel surfaces. Preferably each formed strip has a radially inner end that is centered about the axis of rotation of the formed strip.

The method may include rotating the strip of elastomeric material about an axis of rotation as the strip is applied onto the support surface thereby forming the strip annularly. Alternatively, the support surface can be rotated about an axis of rotation as the strip is applied to form the strip annularly following the contour of the support surface, the forming die being spaced to achieve the proper component dimension.

The strip, when applied to the support surface is formed having a first end and upon about 360° revolution a terminal end can be formed by stopping the flow of extrudate. The terminal end can be and preferably is overlying the first end as a result of the relative movement of the material and the shaping die thereby forming an overlapping joint that appears seamless. The uniformity of the strip cross-sectional profile is maintained by the shaping die and the support surface and extrusion/injection rate.

The method may also include the step of applying additional strips of elastomeric material by annularly overlapping at least a portion of the at least one first strip or another previously applied strip. In this manner a subassembly of uncured tire components can be laminated together.

These additional strips of elastomeric material can then be shaped to predetermined cross sectional profiles by compressing the additional strips of material between a shaping die and the overlapped previously formed strip and the support surface. In one embodiment almost all of an entire green tire is assembled using this method.

In one preferred embodiment this method is used to make elongated bead apexes of uncured elastomeric material. An annular bead core is placed on the support surface and retained such that the axis of rotation is coincident to the axis of rotation of the support surface or the circular path of the extruder. The bead then acts as a material flow stop at the radially inner end. As the extruded strip is placed annularly onto a support surface adjacent the bead core, the shaping die simultaneously compresses the strip of material to a predetermined profile to join the strip to the bead core forming a bead core and uncured apex subassembly.

The above method is performed by an apparatus having an extruder means for forming the elastomeric strip, a support surface, the support surface having a radially inner support rim, a means for rotating the extruder means about the axis of the support rim or alternatively a means for rotating the support surface about the axis of the support rim. The means for rotating creates a relative motion between the extruder means and the support surface thereby enabling the strip to be formed annularly. In close proximity to the outlet end or discharge end of the extruder means is a shaping die. The shaping die in combination with the support surface forms a cavity through which the elastomeric strip is compressed imparting the desired profile or shape of the finished part. Preferably, the die is designed to be oriented at a low angle of attack at about 30° or less relative to the support surface. The leading portion of shaping die channels the strip of material to the end of the shaping die which imparts the parts profile. The die can achieve a completed profile in a rotation of just over 360° for parts. In the manufacture of bead apex subassemblies the radially inner rim is adapted to fit inside the bead core diameter thereby providing support for the bead core. To change bead diameters concentric ring spacers or an adjustable ring mechanism can be attached to the support rim quickly and efficiently.

The support surface can be flat and perpendicular to the axis of rotation or flat and conical, while the shaping die can be of any desired profile or contour. Alternatively, both the support surface and the shaping die can be contoured if so desired. As used herein many of the formed parts are considered oriented substantially perpendicular to the axis of rotation. Several of the formed parts have only portions formed substantially perpendicularly. It is understood that conical and contoured surfaces are not truly perpendicular to the axis; however, if one bisects the formed part along a straight line through the formed part in a portion that when placed in a tire for assembly lies below the tire's crown in the sidewall regions of the tire, the angle relative to the axis is preferably oriented at an angle greater than 45°, generally closer to 90°, relative to the axis of rotation.

This feature greatly reduces the tensioning of parts when compared to parts that were formed horizontal to the axis of rotation and then turned to a more vertical orientation as is common or conventional with tire building drums.

In practice, it is desirable to transfer the formed parts directly to a tire building station without separate storage and handling. In such a case the formed bead apex subassembly can be removed from the support surface and transferred directly to the tire building machine. Most preferably the method can be configured such that the support surface is a toroidially shaped building drum or core. In this method the formed strips are applied directly to the toroidially shaped carcass structure. Using that method liners, sidewalls, chafers, gum strips, ply coats, apexes and other elastomeric strips can be formed.

Definitions

“Aspect ratio” of the tire means the ratio of its section height (SH) to its section width (SW);

“Axial” and “axially” means lines or directions that are parallel to the axis of rotation of the tire;

“Bead” means that part of the tire comprising an annular tensile member with or without other reinforcement elements such as flippers, chippers, apexes, toe guards and chafers, to fit the design rim;

“Belt reinforcing structure” means at least two layers of plies of parallel cords, woven or unwoven, underlying the tread, unanchored to the bead, and having both left and right cord angles in the range from 17 degrees to 27 degrees with respect to the equatorial plane of the tire;

“Carcass” means the tire structure apart from the belt structure, tread, under tread, and sidewall rubber over the plies, but including the beads;

“Circumferential” means lines or directions extending along the perimeter of the surface of the annular tread perpendicular to the axial direction;

“Chafers” refers to narrow strips of material placed around the outside of the bead to protect cord plies from the rim, distribute flexing above the rim, and to seal the tire;

“Chippers” means a reinforcement structure located in the bead portion of the tire;

“Cord” means one of the reinforcement strands of which the plies in the tire are comprised;

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization Standards Manual and the term design rim means the same as the standard measurement rims. In Japan, the standard organization is The Japan Automobile Tire Manufacturer's Association.

“Equatorial plane” (EP) means the plane perpendicular to the tire's axis of rotation and passing through the center of its tread;

“Footprint” means the contact patch or area of contact of the tire tread with a flat surface at zero speed and under normal load and pressure;

“Innerliner” means the layer or layers of elastomer or other material that form the inside surface of a tubeless tire and that contain the inflating fluid within the tire;

“Net-to-gross ratio” means the ratio of the tire tread rubber that makes contact with the road surface while in the footprint, divided by the area of the tread in the footprint, including non-contacting portions such as grooves;

“Normal rim diameter” means the average diameter of the rim flange at the location where the bead portion of the tire seats;

“Normal inflation pressure” refers to the specific design inflation pressure and load assigned by the appropriate standards organization for the service condition for the tire;

“Normal load” refers to the specific design inflation pressure and load assigned by the appropriate standards organization for the service condition for the tire;

“Ply” means a continuous layer of rubber-coated parallel cords;

“Radial” and “radially” means directions radially toward or away from the axis of rotation of the tire;

“Radial-ply tire” means belted or circumferentially-restricted pneumatic tire in which the ply cords which extend from the bead to bead are laid at cord angles between 65 degrees and 90 degrees with respect to the equatorial plane of the tire;

“Section height” (SH) means the radial distance from the nominal rim diameter to the outer diameter of the tire at its equatorial plane; and,

“Section width” (SW) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

### BRIEF DESCRIPTION OF THE DRAWINGS

The invention will be described by way of example and with reference to the accompanying drawings in which:

FIG. 1 is a cross sectional view of a bead apex assembly of the present invention.

FIG. 2 is a cross-sectional view of a multilayer tire component of the present invention.

FIG. 3 is a perspective view of an apparatus of the present invention.

FIG. 4 is an enlarged view of a shaping die and extruder head applying an elastomeric strip onto a support surface of the present invention.

FIG. 4A is a view similar to FIG. 4 showing a spiral layered formed strip.

FIG. 5 is a cross-sectional view of the apparatus of FIG. 4.

FIGS. 6 through 13 depict an embodiment of the invention wherein formed strips are applied directly onto a toroidially shaped building core or bladder to create a complete tire component.

FIG. 6 shows a tire building drum and a robotic controlled extruder head and forming die connected to a robotic device.

FIG. 7 is an enlarged view of the extruder head and die assembly.

FIG. 8 is a cross-sectional view of the forming die assembly.

FIG. 9 is an enlarged perspective view of the forming die assembly.

FIG. 10 shows the robotic controlled extruder head and forming die abutted to permit applying a complete innerliner.

FIG. 11 shows the robotic extruder head and forming die applying a ply coat layer.

FIG. 12 shows the robotic controlled extruder heads and forming dies applying a pair of apexes.

FIG. 13 shows the carcass having belt layers applied.

FIG. 14 shows a robotic controlled extruder head and forming die applying a side wall and a crown cushion layer.

FIG. 15 shows a robotic controlled extruder head and forming die applying a tread to the carcass belt assembly.

FIG. 16 shows a tire curing mold for molding the tire.

### DETAILED DESCRIPTION OF THE INVENTION

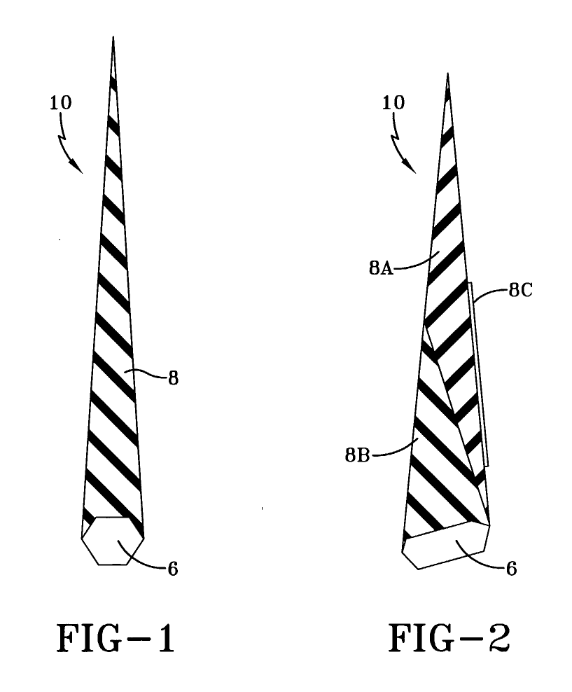

With reference to FIGS. 1 and 2, an exemplary tire component is shown. The tire component as illustrated is a bead apex 10 made of elastomeric material and radially inward of the bead apex is an annular tensile member commonly referred to as a bead core 6. In FIG. 2 the bead apex 10 is shown as a multilayered elastomeric component formed by at least two distinct rubber compounds 8A, 8B, and 8C. Such multilayered apex components 10 are used in the manufacture of commercial truck tires, for example.

These components actually space the carcass ply cords from the ply tumup and tend to help structurally stiffen the tire structure. The use of the bead apex 10 can actually reduce the amount of stresses and strains in the tire during use. Ideally the apex is formed with an elongated triangular cross-sectional shape.

In conventional tire building such components such as the bead apex and rubber sidewalls are formed as an extruded strip of generally a flat cross section. The components are spliced on a tire building drum and have their axis of rotation parallel to the axis of the tire building drum. The assembled components are then folded over in a procedure of tire building commonly known as the ply turnup step. These uncured parts are then stitched to a carcass assembly. This procedure rolls these parts 180° wherein the axially outer ends are turned axially inwardly. After that a tire building bladder expands in a doughnut or toroidial shape as the bead portions of the carcass are held in a clamped position. The beads are allowed to move axially inwardly thereby allowing the carcass to be shaped torroidally by the expanded bladder. The components such as the apex and the sidewalls are then forced to an almost vertical or radially outwardly extending orientation wherein the components' axis of rotation is shifted from parallel to the axis of the building drum to almost perpendicular. The actual shaping of these green or uncured rubber parts creates residual stress that during the tire vulcanization process caused the various components to slip as they soften during curing. This slipping relaxes the built-in strains and stresses but also means the location of and tension of the ply and belt cords in the finished product is much less predictable giving rise to tire non-uniformity.

Ideally, to make a uniform tire the components should be built with no built-in internal stress. Reduction in such stresses is therefore a desirable design goal.

These thin elongated parts of uncured rubber strips are generally produced off line relative to the tire building station. This off-line extruding means the parts must be sufficiently durable to survive material handling.

In the case of bead apexes this means the thin radially outer tip portion must be terminated. The thin end is too susceptible to damage and premature stretching and puckering. When puckering occurs the components cannot be stitched without wrinkles.

Attempts to solve these problems have led many designers to try precuring the bead apex assembly. In this way the molded bead apex becomes much more durable; however, precured components are much harder to stick to the other uncured tire components. Accordingly, the slippage problem between the cured and uncured parts during vulcanization becomes exaggerated creating another form of tire uniformity issues.

The present invention provides a novel way to form elastomeric tire components quickly and efficiently. The method permits the components to be made annularly in an uncured state and the axis of the annular components can be non-parallel to the circumferential length of the part. In fact, the parts can be made at any desired angle relative to the axis. In cases where the finished product is oriented at 45° or more relative to the tire's axis the part can be formed to that desired finished product angle. The method allows angles substantially perpendicular to the tire's axis to be easily achieved which means the components can be formed very close to the as-molded shape and orientation.

Such component fabrication is easily adapted to be coupled to the tire building equipment thus avoiding storage problems. This enables parts with very thin flimsy tips to be utilized without the fear of material handling problems.

Alternatively, the parts can be made and stored for later use, recognizing the associated issues of handling and aging of rubber parts.

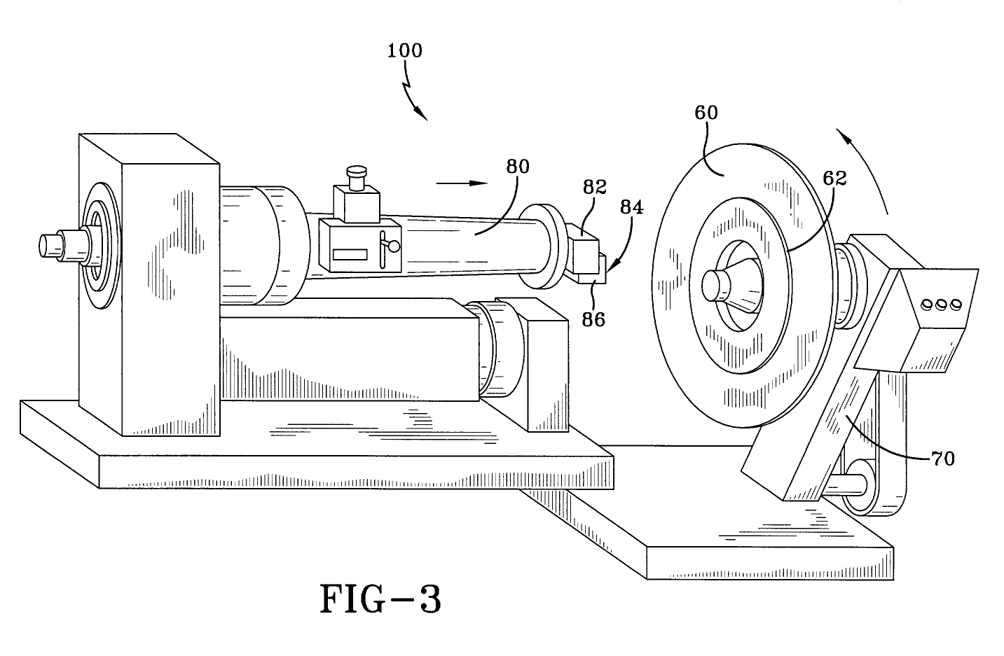

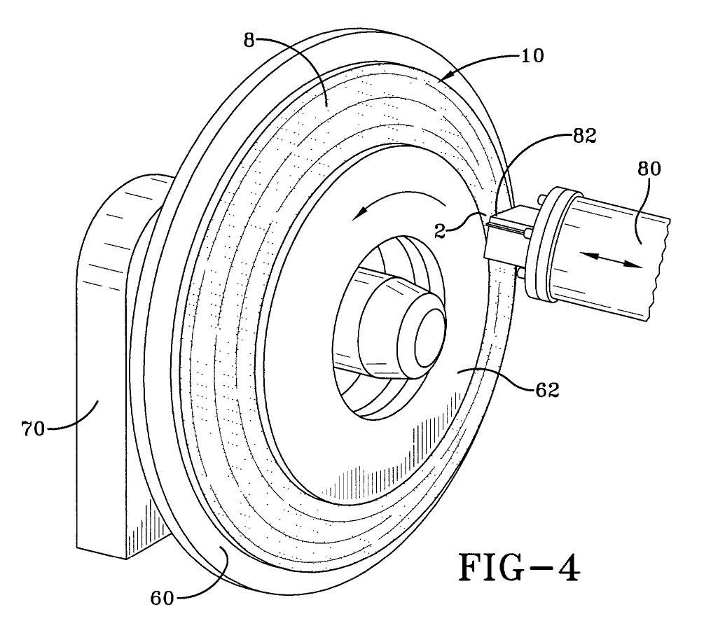

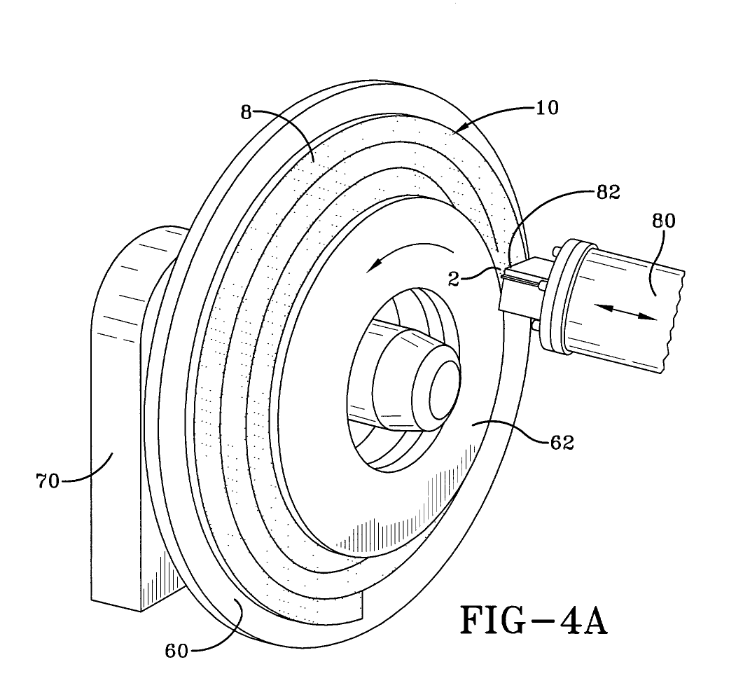

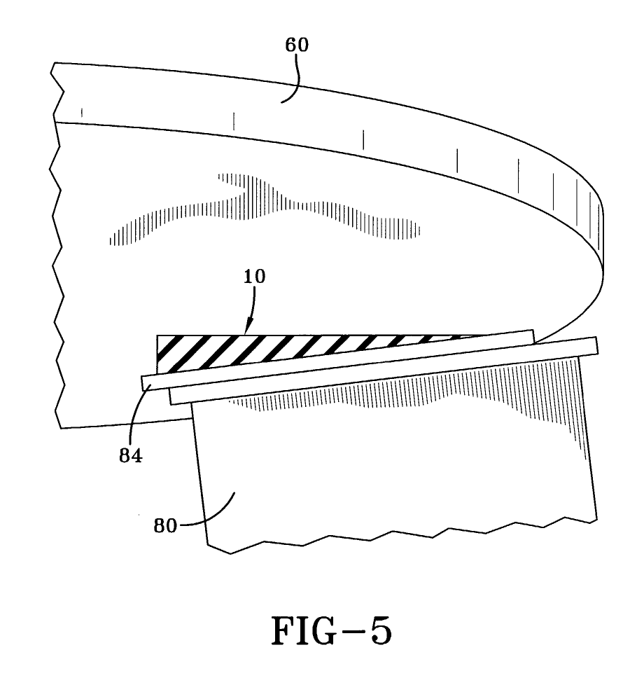

The method to achieve this type of part is best illustrated with reference to FIGS. 3 through 5 showing an exemplary apparatus.

As shown the exemplary apparatus 100 has an extruder means 80 for forming an elastomeric strip 10, a support surface 60, and a means 70 for rotating the extruder means or alternatively the support surface about the axis of rotation of the support rim 62.

As shown the support surface 60 has a radially inner support rim 62. The support rim 62 acts like a ledge to provide an end for the formed component 10. The rim 62 as will be discussed also can hold a bead core 6 in place so an apex 10 can be formed and attached directly to the bead core 6.

To make different bead diameter tires using the same support surfaces 60, one simply can add concentric support rings onto the support rim 62 thereby increasing the diameter.

The support surface 60 can be flat, conical shaped or could be profiled having a curved surface. It must be appreciated this support surface 60 is forming one of the radially extending surfaces of the formed strip. The surface 60 can be an axially inner or an axially outer surface or both depending on the profile required to form the strip. The fact that the material is formed and applied in the orientation very close to the toroidially shaped green or uncured tire means the residual stresses particularly at the radially outer ends of the formed parts are virtually non-existent. This greatly approves the overall quality and uniformity of the formed components.

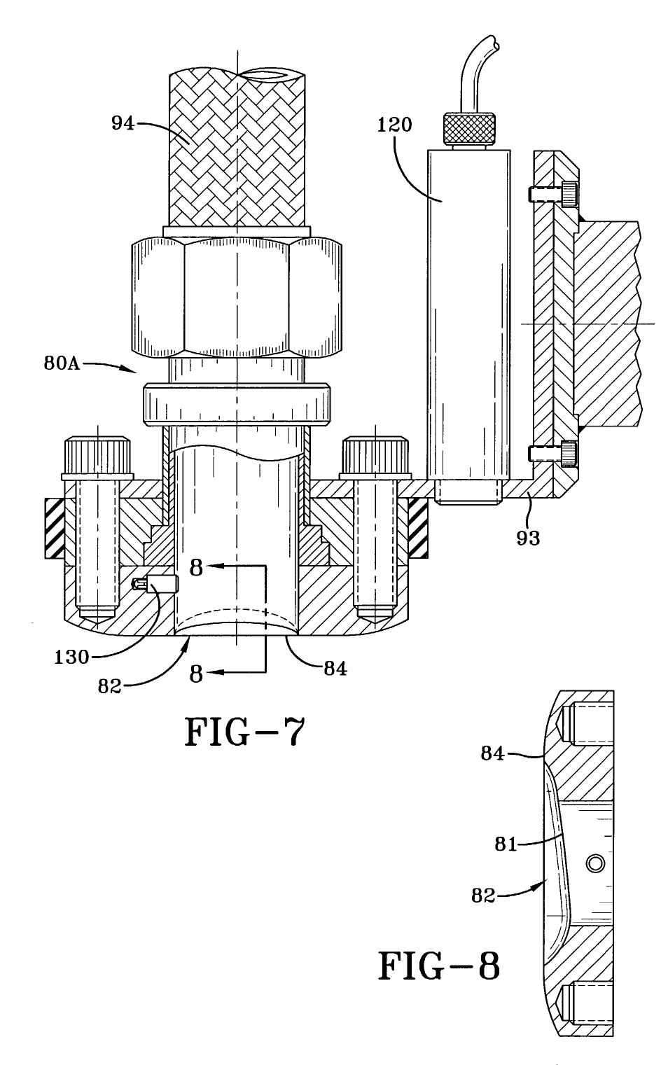

The extruder means 80 may be an extruder only or an extruder in combination with a gear pump or injector. As shown the extruder means applies the elastomeric material, typically rubber directly onto the support surface 60. The extruder means 80 can be mounted for vertical discharge or horizontal discharges dependent on the orientation of the support surface 60 as shown in FIG. 7. The tip or discharge end 81 of the extruder preferably has a rough initial profile forming die 82 that shapes the part generally close to the shape of the finished product. Accordingly, the extruded initial profile die 82 can be a thin rectangular strip forming shape.

In practice the extruder discharges at an initial starting point and the strip is applied annularly by either rotating the extruder means 80 or the support means 60 about an axis of rotation.

A final shaping die 84 follows directly behind the extruder tip and as the rubber material is discharged onto the support surface 60 the final shaping die 84 compresses the material into a cross-sectional profile of the desired shape.

In practice both discharge end 81 of the extruder 80 and the final shaping die 84 are oriented at an angle of less than 90° relative to the support surface. The extruder discharge end 81 can be at any angle off normal such that the angle as shown applies the material more uniformly. The final shaping die 84 can be inclined at a much lower angle of attack having a leading or initial contact angle of less than 45° and at the trailing or finish end where the final shaping occurs preferably has a polishing or smearing angle of 0° to 20°.

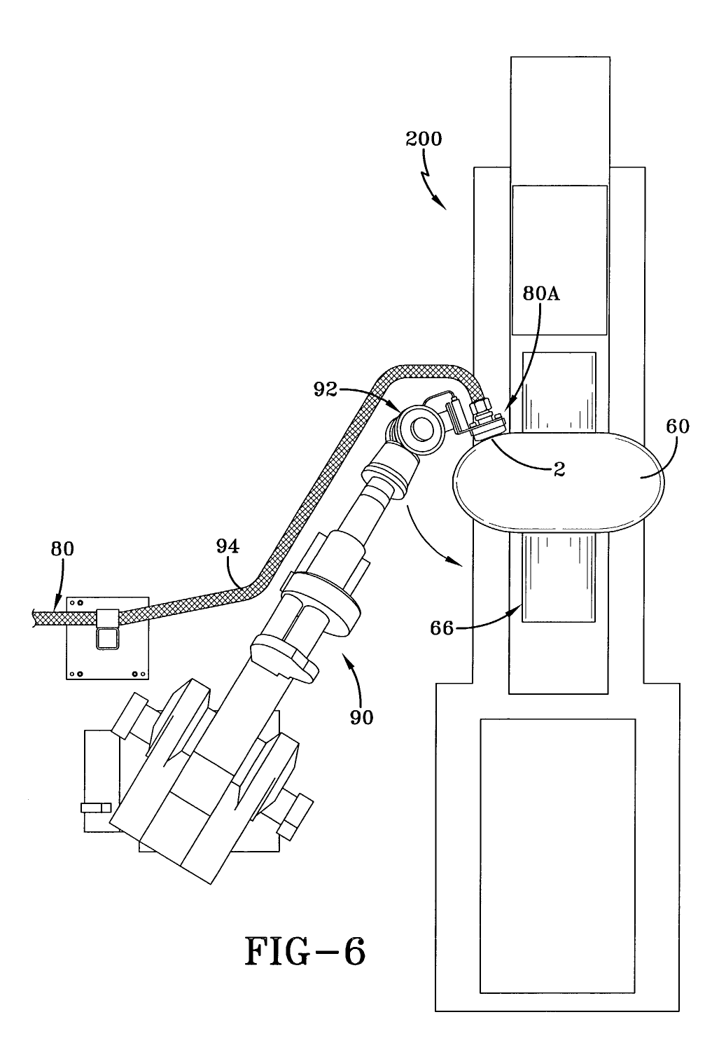

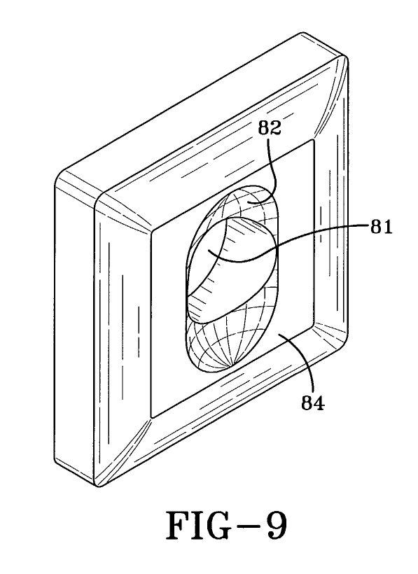

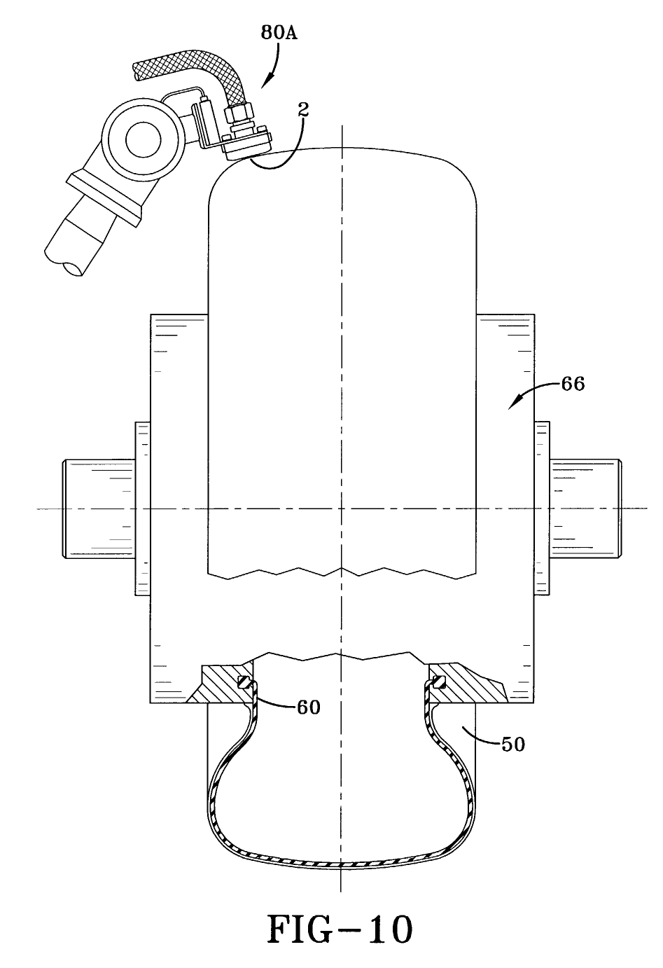

A more sophisticated embodiment of the invention is shown in FIGS. 6-16. In this embodiment a robot 90 with a multiple axis movable arm 92 is connected to the extruder means 80 and the elastomeric extrudate passes through flexible hose 94 to the extruder forming assembly 80A which includes a discharge end 81, initial profile die 82 and the final shaping die 84.

As in the previously discussed apparatus 100 of FIGS. 3-5 the extrudate is fed out in strips 2 onto a support surface 60. The support surface 60 as shown is a toroidially expanded building drum 66. The drum 66 can be radially expandable as shown using an incompressible fluid medium or high pressure air, alternatively the toroidal shape may be formed of a rigid or solid core. The primary advantage of applying the strip 2 to a toroidially shaped surface is the finished part is accurately positioned in a green uncured state at the proper orientation to be molded without requiring any change in orientation from the condition in which the strip was initially formed.

As shown the apparatus 200 is a tire building station 200. The exemplary robot employs a single universal forming assembly 80A which can feed multiple compounds through a flexible hose assembly 94 with separate feed channels for delivering the proper compound to the discharge tip 81. As the strip material 2 is fed into the initial profile forming die 82, the support surface 60 rotates enabling the strip 2 to be formed annularly. The robotic arm 92 precisely moves as required to insure the final forming die 84 spreads the elastomeric material to the exact shape and thickness desired. This may be accomplished in as few as one rotation of the support surface for small narrow components or may require several rotations for thick or very wide components. The profile of each formed component can be varied in a fashion such that the cross-sectional thickness is very thin as in the tip of an apex or thick near the bead core. Also the entire profile can be thin as in a liner component. The robotic arm can articulate moving in numerous directions the numerous degrees of freedom enables the shaping die to form flat convex or concave curvatures as the material is spread.

As shown in FIG. 7 the forming assembly 80A is physically attached to the robot by the bracket 93. A laser sensor 120 detects the distance from the support surface 60. This measured distance is fed back to a computer which is programmed to direct the robotic arm to move axially and radially along the flow path as the precise amount of strip material is placed onto the support surface or directly onto a previously formed component. As shown a pressure sensor 130 is embedded in the forming die 82, the pressure sensor 130 reads the applied pressure of the forming die to insure the extrudate is properly smeared. As can be easily appreciated the smearing of the strip requires a pressure that does not overly squeeze the material against the surface to which the part is being applied.

In FIGS. 10 through 16 the apparatus 200 is shown forming a tire assembly. While the many components are shown being applied using the apparatus 200 several cord reinforced components such as the belts, carcass plies and the chipper can be applied using previously calendered materials. Similarly the tread may be provided in a strip or an annular ring in a more conventional manner. What is important to note is some or all of these tire components can be formed using this technique of the present invention. The tire manufacturer simply can choose which components can be most efficiently produced using this technique.

In FIG. 10, the innerliner 50 is being applied to the support surface 60. The inner liner 50 generally is made of halobutyl rubber and provides an air impervious barrier for tubeless tires.

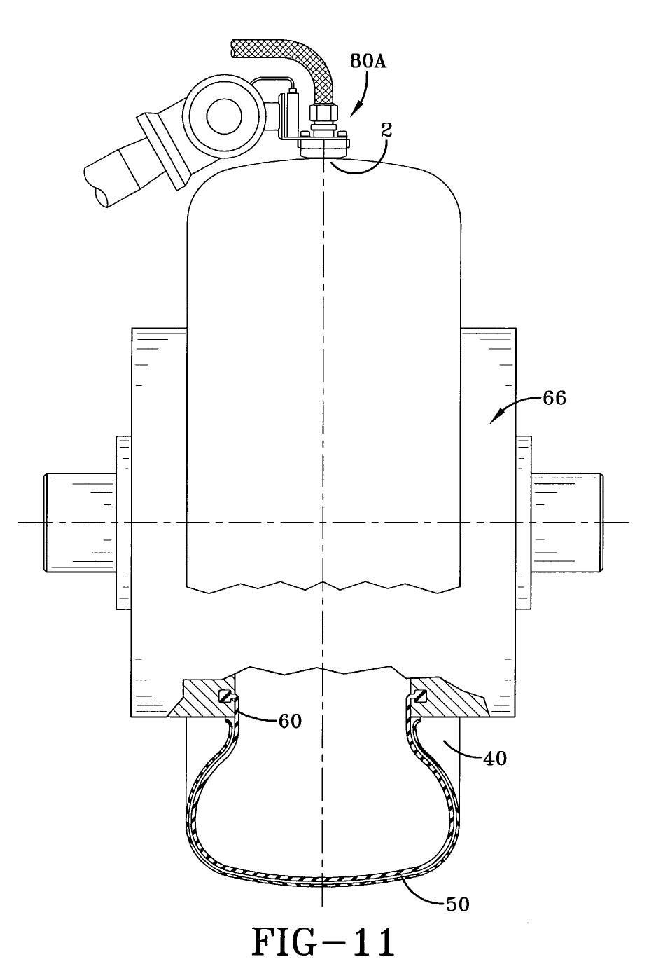

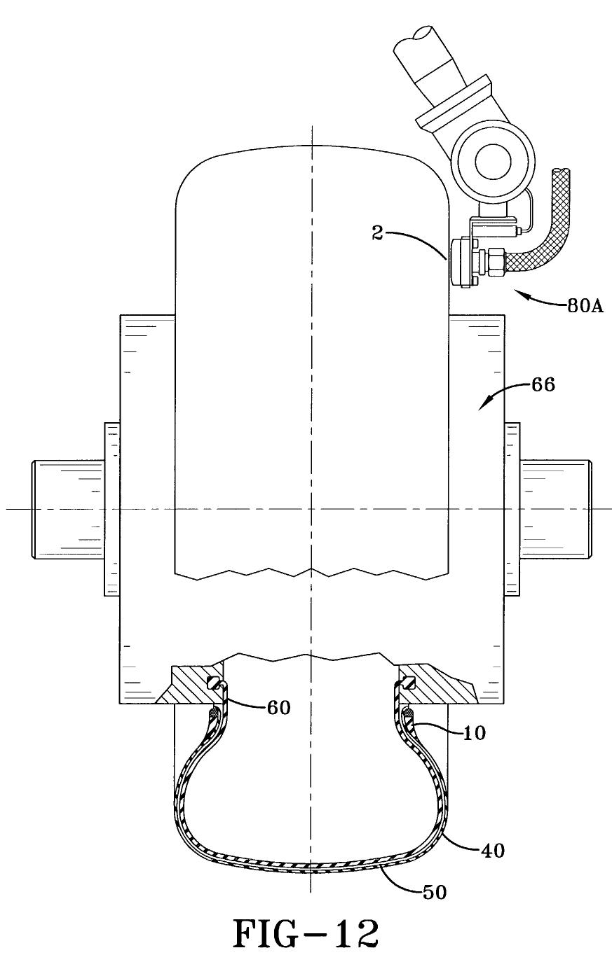

In FIG. 11, the ply stock coating 40 is shown being smeared onto the liner. Assuming cord reinforcements are used they will be applied onto the ply stock as a sheet or otherwise applied.

In FIG. 12, the apex 10 is shown being applied directly over the bead cores 6 and against the ply stock.

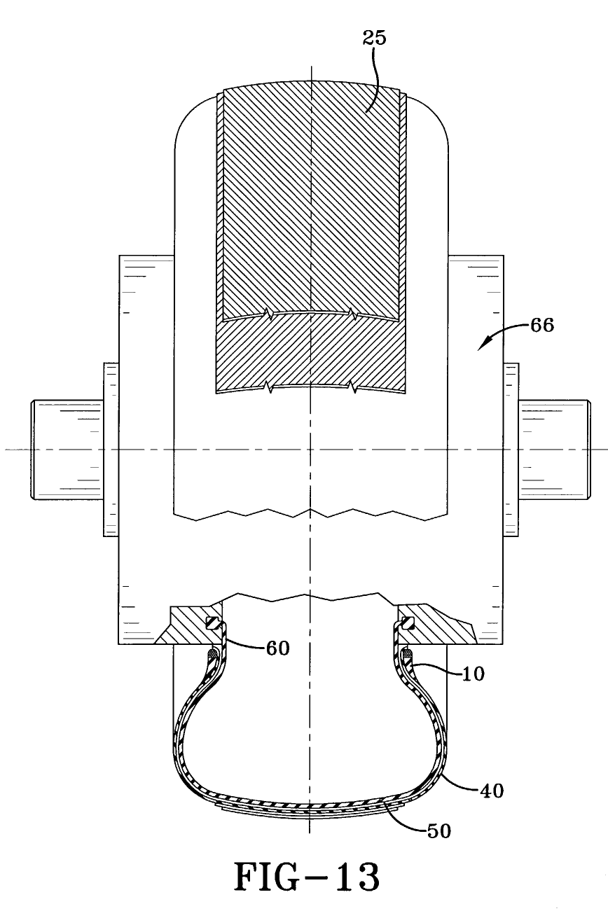

In FIG. 13, the belt reinforcing structure 25 is shown being applied in a conventional manner. The belt structure has two layers 27, 28 with oppositely oriented layers.

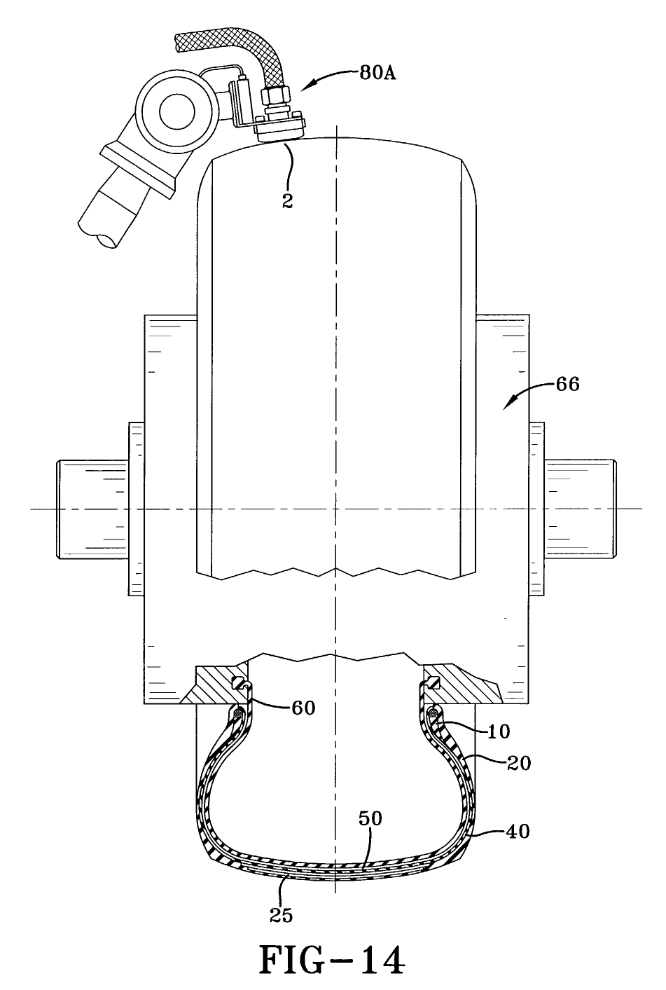

FIG. 14 shows the sidewalls 20 and crown cushion layer being applied using the present invention. Each sidewall is applied over the bead apex and the ply coating 40.

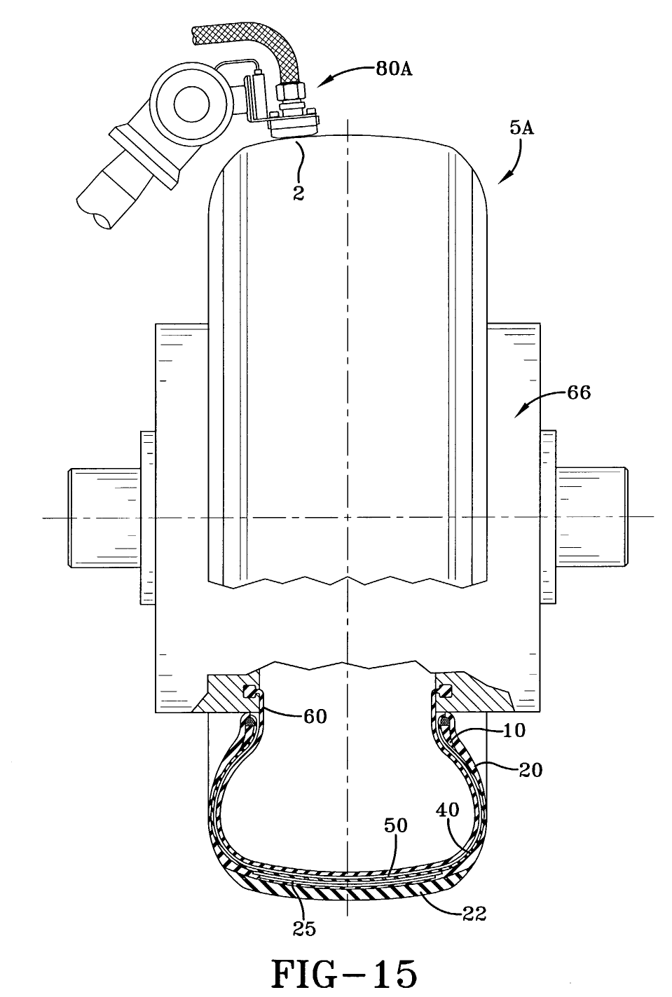

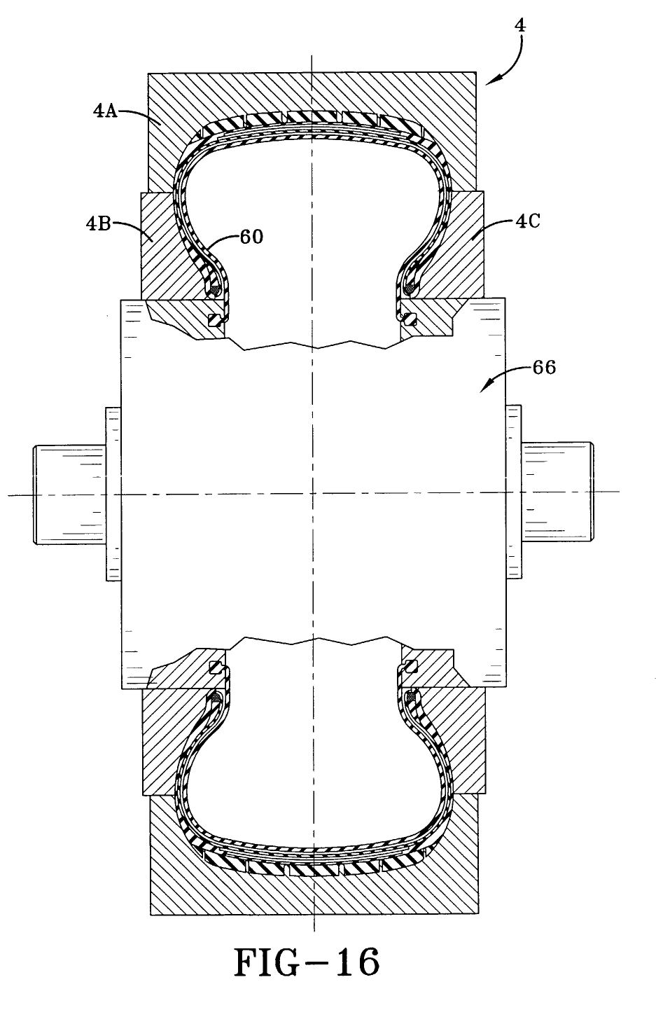

FIG. 15 shows the tread 22 being applied using the present invention. Often the tread is a complex structure having multiple layers. In such a case the tread 22 may be applied in multiple passes using the contouring profiling techniques previously discussed.

In FIG. 16 the uncured green tire 5 is shown being enveloped by a mold right at the tire building station core. The mold 4 has a plurality of radially outer segments 4A and a pair of side plates 4B and 4C. The tire can then be cured under heat and pressure.

As shown in FIGS. 10 through 16 the entire tire building process can be efficiently completed taking strips of components and applying them on the support surfaces 60 shaping the components into a desired profile.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of forming an annular elastomeric tire component; comprising the steps of
extruding a first strip of elastomeric material annularly onto a surface,
shaping the first strip of elastomeric material to a predetermined profile by compressing the first strip of material between a shaping die and the surface, the profile having a radially extending surface extending between a radially inner end and a radially outer end substantially perpendicular to the axis of rotation of the annular strip.

2. The method of forming an annular elastomeric tire comprising the steps
overlapping a first end of the first strip with a terminal end of the first strip by passing the first end and the terminal end between the shaping die and the terminal end.

3. The method of forming an annular elastomeric tire component of claim 1 further comprises the step of
rotating strip of elastomeric material about an axis of rotation as the strip is applied onto a surface to form the strip assembly.

4. The method of forming an annular elastomeric tire component of claim 1 further comprises the step of
rotating the surface about an axis of rotation as the strip is applied to form the strip annularly and substantially perpendicular to the axis.

5. The method of forming an annular elastomeric tire component of claim 1 further comprises the step of:
extruding a second strip of elastomeric material annularly overlapping at least a portion of the first strip and the surface
shaping the second strip of elastomeric material to a predetermined cross-sectional profile by compressing the second strip of material between a shaping die and the overlapped first strip and the surface.

6. The method of forming an annular elastomeric tire component of claim 1 further comprises the steps of:
placing an annular bead core onto a surface; and then
extruding a strip of elastomeric material annularly onto a surface adjacent the bead core;
shaping the strip of elastomeric material to a predetermined profile by compressing the strip of material between the bead core, the surface, and a shaping die to form an annular bead apex joined to the bead core.

7. The method of forming an annular elastomeric tire component of claim 1, wherein the step of extruding a first strip of elastomeric material annularly onto a surface includes spirally applying multiple passes of the first strip of elastomeric material onto the surface.

8. The method of forming an annular elastomeric tire component of claim 7 wherein the step of shaping the spirally wound first strip of elastomeric material includes the step of moving the shaping die radially outwardly as the strip is applied.
